(19) United States
(12) Patent Application Publication
(10) Pub. No.: US 2026/0110798 A1
(43) Pub. Date: Apr. 23, 2026

(54) VELOCITY ESTIMATION DISTORTION CORRECTION

(71) Applicant: QUALCOMM Incorporated, San Diego, CA (US)

(72) Inventors: Per Johan HOLM, Vendelsö (SE); Jacob ROLL, Linköping (SE); Gustav Nils Ture PERSSON, Ljungsbro (SE); Andreas EIDEHALL, Linköping (SE)

(21) Appl. No.: 19/000,418

(22) Filed: Dec. 23, 2024

Related U.S. Application Data
(60) Provisional application No. 63/709,325, filed on Oct. 18, 2024.

(51) Int. Cl. G01S 17/58; G01S 17/89; G01S 17/931

(52) U.S. Cl. CPC G01S 17/58; G01S 17/89; G01S 17/931

(57) ABSTRACT

In some aspects, an apparatus may receive, from a lidar sensor, a bounding geometry in accordance with one or more data points of a point cloud representing two or more scans of a sensed object. The bounding geometry may have a bounding volume associated with the sensed object. The apparatus may extend the bounding volume of the bounding geometry to enclose at least a subset of the data points in the point cloud. The apparatus may estimate a data point displacement in accordance with two or more subsets of the data points of the point cloud. The apparatus may estimate a velocity of the sensed object in accordance with the data point displacement. Numerous other aspects are described.

### CROSS-REFERENCE TO RELATED APPLICATION

This Patent Application claims priority to Provisional Ser. No. 63/709,325, filed on Oct. 18, 2024, entitled “VELOCITY ESTIMATION DISTORTION CORRECTION,” and assigned to the assignee hereof. The disclosure of the prior Application is considered part of and is incorporated by reference into this Patent Application.

### FIELD OF THE DISCLOSURE

Aspects of the present disclosure generally relate to processing sensor data and, for example, to correcting distortion related to a velocity estimation.

### BACKGROUND

A light detection and ranging (lidar) system is a remote sensing system that involves the emission of laser light pulses from a light source. The laser light pulses reflect off of one or more objects, the reflected laser light is detected by a detector that measures a time of flight of the reflected laser light, and the time of flight corresponds to a distance between the light source and the object. The lidar system further includes a processor that calculates distance or depth from the time of flight of the reflected laser light. The processor generates a three-dimensional point cloud that represents the scanned environment, including the object.

### SUMMARY

Some aspects described herein relate to an apparatus. The apparatus may include one or more memories and one or more processors coupled to the one or more memories. The one or more processors may be individually or collectively configured to receive a bounding geometry associated with one or more data points of a point cloud representing two or more scans of an environment that includes a sensed object. The bounding geometry may have a bounding volume associated with the sensed object. The one or more processors may be individually or collectively configured to extend the bounding volume of the bounding geometry to enclose at least a subset of the data points in the point cloud. The one or more processors may be individually or collectively configured to estimate a data point displacement in accordance with two or more subsets of the data points of the point cloud. The one or more processors may be individually or collectively configured to estimate a velocity of the sensed object in accordance with the data point displacement.

Some aspects described herein relate to a method. The method may include receiving a bounding geometry associated with one or more data points of a point cloud representing two or more scans of an environment that includes a sensed object. The bounding geometry may have a bounding volume associated with the sensed object. The method may include extending the bounding volume of the bounding geometry to enclose at least a subset of the data points in the point cloud. The method may include estimating a data point displacement in accordance with two or more subsets of the data points of the point cloud. The method may include estimating a velocity of the sensed object in accordance with the data point displacement.

Some aspects described herein relate to a non-transitory computer-readable medium that stores a set of instructions that, when individually or collectively executed by one or more processors, may cause the apparatus to receive a bounding geometry associated with one or more data points of a point cloud representing two or more scans of an environment that includes a sensed object. The bounding geometry may have a bounding volume associated with the sensed object. The set of instructions, when individually or collectively executed by one or more processors, may cause the apparatus to extend the bounding volume of the bounding geometry to enclose at least a subset of the data points in the point cloud. The set of instructions, when individually or collectively executed by one or more processors, may cause the apparatus to estimate a data point displacement in accordance with two or more subsets of the data points of the point cloud. The set of instructions, when individually or collectively executed by one or more processors, may cause the apparatus to estimate a velocity of the sensed object in accordance with the data point displacement.

Some aspects described herein relate to an apparatus for wireless communication. The apparatus may include means for receiving a bounding geometry associated with one or more data points of a point cloud representing two or more scans of an environment that includes a sensed object, wherein the bounding geometry has a bounding volume associated with the sensed object. The apparatus may include means for extending the bounding volume of the bounding geometry to enclose at least a subset of the data points in the point cloud. The apparatus may include means for estimating a data point displacement in accordance with two or more subsets of the data points of the point cloud. The apparatus may include means for estimating a velocity of the sensed object in accordance with the data point displacement.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example associated with velocity estimation distortion correction, in accordance with the present disclosure.

FIG. 2 is a diagram illustrating an example associated with correcting bounding geometry distortion caused by a moving sensed object, in accordance with the present disclosure.

FIG. 3 is a diagram illustrating example components of a device, in accordance with the present disclosure.

FIG. 4 is a diagram illustrating an example associated with processing a bounding geometry, in accordance with the present disclosure.

FIG. 5 is a diagram illustrating an example associated with generating a corrected bounding geometry, in accordance with the present disclosure.

FIG. 6 is a flowchart of an example process associated with velocity estimation distortion correction, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A vehicle, such as an automobile, may include a light detection and ranging (lidar) sensor to sense other vehicles, infrastructure, pedestrians, or other objects in an environment around the vehicle. The lidar sensor may sense one or more sensed objects in the environment by performing a 360-degree sweep and outputting a point cloud that can be used to generate a bounding geometry for one or more of the sensed objects. The bounding geometry may be generated in accordance with the point cloud, which includes a collection of data points that represent spatial coordinates of surfaces within a three-dimensional space (e.g., the environment) around the lidar sensor.

The data that makes up the point cloud, however, are not collected at the same time. Because the lidar sensor operates by performing a 360-degree sweep of the environment, the data collected at the end of the sweep lags the data collected at the beginning of the sweep, which can result in a point cloud distortion if the lidar sensor is mounted to a moving object and/or if the sensed object is moving. For example, when a lidar sensor detects a sensed object, the lidar sensor may detect a front of the sensed object before the lidar sensor detects a rear of the sensed object. If the sensed object is moving, the rear of the sensed object will not be at the same location (relative to the front of the sensed object) as it was when the front of the sensed object was detected. Depending on how the sensed object is moving (e.g., toward the lidar sensor or away from the lidar sensor), the point cloud representing the sensed object may indicate that the sensed object is longer or shorter in one or more dimensions. Accordingly, the movement of the lidar sensor and/or the sensed object may result in a point cloud distortion, where the point cloud does not accurately represent one or more dimensions of the sensed object.

If the lidar sensor is mounted to a moving object but the object being sensed is stationary, the lidar sensor may compensate for the distortion in the point cloud before outputting the bounding geometry. For example, the lidar sensor may adjust the bounding geometry in accordance with a speed of the object on which the lidar sensor is mounted. The lidar sensor, however, cannot correct for the distortion of a moving sensed object unless the lidar sensor knows or can determine how fast the sensed object is moving. If the lidar sensor is unable to address the distortion caused by moving sensed objects, accuracy of the lidar sensor output may be limited, particularly with respect to automotive environments where sensed objects are expected to move.

One way to address distorted bounding geometries is to manually annotate a bounding geometry. Manually annotating a distorted bounding geometry is expensive and time-consuming. Further, manually annotating a distorted bounding geometry can be inaccurate if, for example, the manually annotated bounding geometry is simply the distorted bounding geometry shifted in a direction of travel of the moving sensed object. Shifting the distorted bounding geometry does not necessarily address stretching or shrinking of the bounding geometry caused by the velocity of the moving sensed object and the delay between measurements by the lidar sensor. When a high degree of accuracy is necessary, relying on manual annotations of the bounding geometry may limit the applicability of the lidar system to real-time scenarios involving moving sensed objects.

In some aspects, rather than relying on manual annotations of the distorted bounding geometry, a computing device, such as a vehicle computer, lidar processor, and/or a combination thereof, among other examples, may process and correct the distorted bounding geometry to generate a corrected bounding geometry that removes or reduces the distortion of the bounding geometry caused by the moving sensed object. For example, the computing device may estimate a speed of the sensed object based on multiple lidar sweeps. With the estimated velocity, the computing device may correct one or more data points of the distorted bounding geometry output by the lidar sensor. By correcting the distorted bounding geometry, the vehicle computer may generate the corrected bounding geometry to more accurately represent one or more dimensions (e.g., a length) of the sensed object relative to the distorted bounding geometry. By having the computing device correct the distorted bounding geometry, the corrected bounding geometry can be generated in real-time rather than through a manual process, which as discussed above is expensive and time-consuming. Further, by estimating the velocity of the moving sensed object, the computing device may determine and apply a compensation vector to one or more data points of the distorted bounding geometry, which may result in a more accurate corrected bounding geometry than a bounding geometry that has been corrected manually.

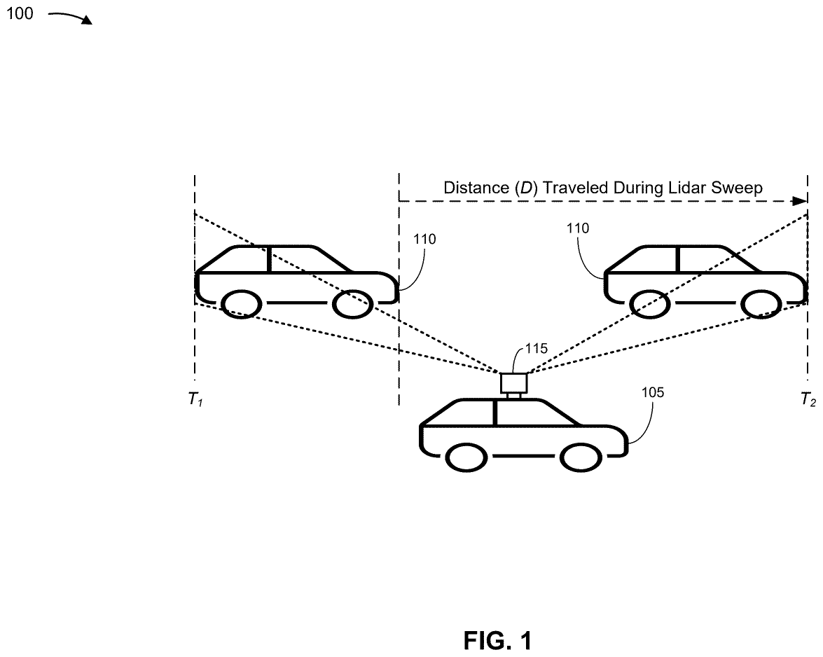

FIG. 1 is a diagram illustrating an example 100 associated with velocity estimation distortion correction, in accordance with the present disclosure. As shown in the example 100 of FIG. 1, a first vehicle 105 may detect a second vehicle 110 using a lidar sensor 115.

In some aspects, the first vehicle 105 may be any form of transportation (e.g., a passenger vehicle, a commercial vehicle, or a public transportation vehicle, among other examples) that supports, and receives an output of, the lidar sensor 115. In some aspects, the first vehicle 105 may be equipped with mounting hardware or fixtures to secure the lidar sensor 115 at a designated position, which may allow the lidar sensor 115 to scan an environment around the first vehicle 105. The first vehicle 105 may be moving or may be stationary during a lidar sweep performed by the lidar sensor 115.

The second vehicle 110 may be a vehicle (e.g., a passenger vehicle, a commercial vehicle, or a public transportation vehicle, among other examples) that travels in proximity to the first vehicle 105 during the lidar sweep by the lidar sensor 115. The second vehicle 110 may travel a distance D over a time period that begins at time T₁ and ends at time T₂. The movement of the second vehicle 110 during the time period may cause distortion in a bounding geometry output by the lidar sensor 115, as discussed in greater detail below.

In some aspects, the lidar sensor 115 may be configured to perform a sweep of the surrounding environment during a period of time that includes the time T₁ and the time T₂. In some aspects, the lidar sensor 115 may emit laser pulses that are reflected off objects, including the second vehicle 110, in the environment around the first vehicle 105. The lidar sensor 115 may be configured to generate an output that represents one or more sensed objects in the environment. In some aspects, the output of the lidar sensor 115 may include a point cloud, having one or more data points, that can be used to generate a bounding geometry, such as a bounding box. In some aspects, the bounding geometry may have a bounding volume associated with the sensed object. In some aspects, the bounding geometry may include one or more data points of a point cloud representing a scan (e.g., lidar sweep) of the sensed object. In some aspects, the sensed object may include the second vehicle 110. In some aspects, the point cloud output by the lidar sensor 115, and the resulting bounding geometry, may be distorted if, for example, the second vehicle 110 is moving during the scan performed by the lidar sensor 115.

As indicated above, FIG. 1 is provided as an example. Other examples may differ from what is described with respect to FIG. 1.

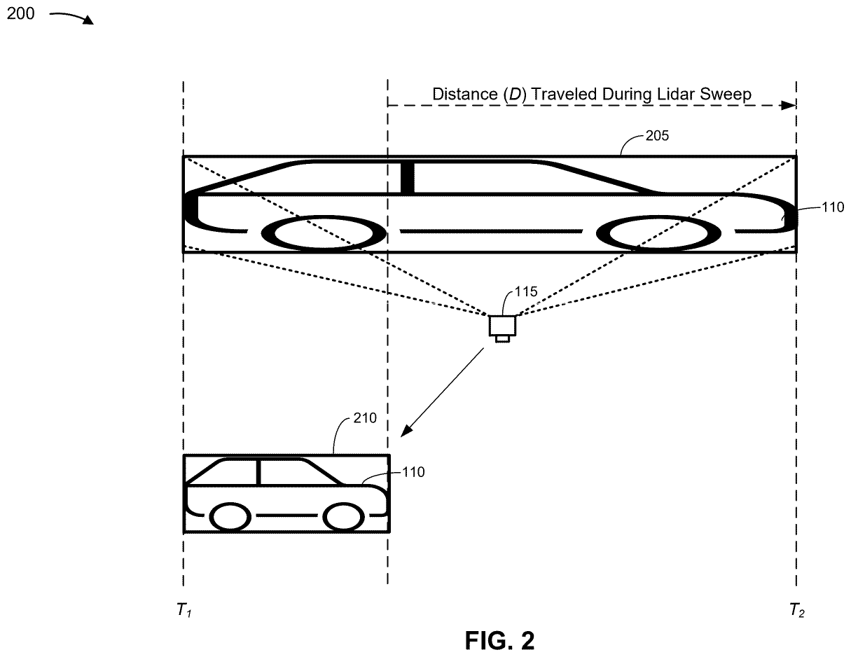

FIG. 2 is a diagram illustrating an example 200 associated with correcting bounding geometry distortion caused by a moving sensed object, in accordance with the present disclosure. In the example 200 of FIG. 2, the lidar sensor 115 may output an initial bounding geometry 205. In some circumstances, such as if the sensed object (e.g., the second vehicle 110 of FIG. 1) is moving, the bounding geometry 205 may be distorted. In some aspects, as discussed in greater detail below, the distortions of the bounding geometry 205 may be corrected to generate a corrected bounding geometry 210.

As discussed above, the point cloud used to develop the bounding geometry 205 may include a collection of data points captured by the lidar sensor 115 during a scan of an environment around the lidar sensor 115 (e.g., as shown in the example 100 of FIG. 1). In some aspects, each data point in the point cloud may correspond to a location in space that represents the distance between the lidar sensor 115 and a sensed object (e.g., the second vehicle 110) in the environment. The lidar sensor 115 may output the point cloud that may be used to generate the initial bounding geometry 205 in accordance with the data points collected between time T₁ and time T₂. The initial bounding geometry 205 may be distorted if, for example, the sensed object is moving (e.g., traveling the distance D) during the lidar sweep. When distorted, the initial bounding geometry 205 may represent an incorrect spatial representation of the second vehicle 110 as detected by the lidar sensor 115.

As discussed in greater detail below, the distortion of the initial bounding geometry 205 may be corrected. For example, in some aspects, the corrected bounding geometry 210 may represent a corrected version of the initial bounding geometry 205. In some aspects, the corrected bounding geometry 210 may account for movement of the sensed object during the lidar sweep. In some aspects, the corrected bounding geometry 210 may be generated by processing the data points in the point cloud used to generate the initial bounding geometry 205 to compensate for the movement of the target during the lidar sweep. By correcting the data points used to generate the initial bounding geometry 205, the corrected bounding geometry 210 may more accurately represent the sensed object as detected by the lidar sensor 115.

As indicated above, FIG. 2 is provided as an example. Other examples may differ from what is described with respect to FIG. 2.

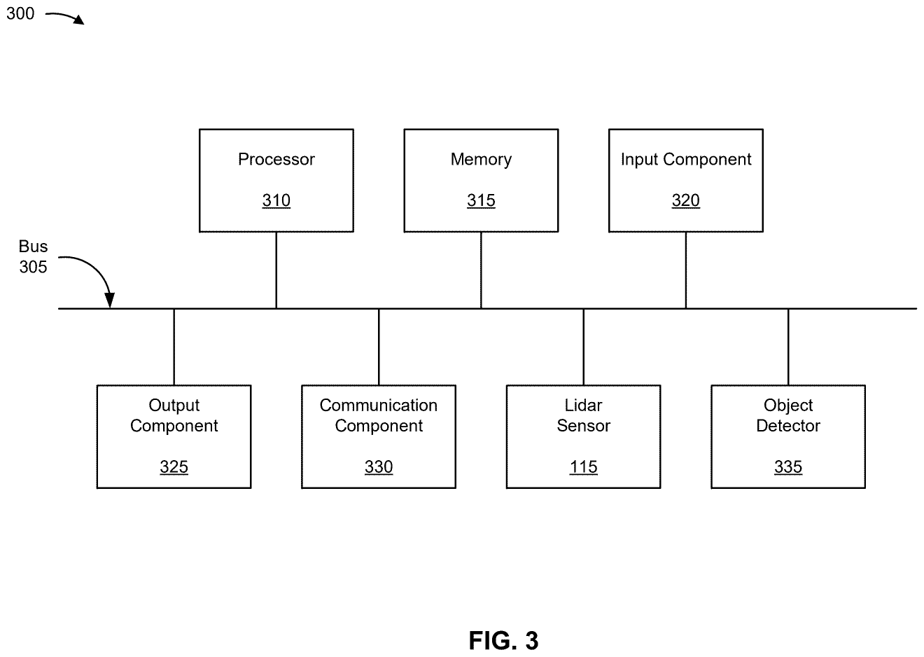

FIG. 3 is a diagram illustrating example components of a device 300, in accordance with the present disclosure. The device 300 may correspond to the first vehicle 105 of FIG. 1.

In some aspects, the first vehicle may include one or more devices 300 and/or one or more components of the device 300. As shown in FIG. 3, the device 300 may include a bus 305, a processor 310, a memory 315, an input component 320, an output component 325, a communication component 330, and a lidar sensor 115.

The bus 305 may include one or more components that enable wired and/or wireless communication among the components of the device 300. The bus 305 may couple together two or more components of FIG. 3, such as via operative coupling, communicative coupling, electronic coupling, and/or electric coupling. For example, the bus 305 may include an electrical connection (e.g., a wire, a trace, and/or a lead) and/or a wireless bus. In some aspects, the bus 305 may include a vehicle communication bus (e.g., a controller area network (CAN) bus, a local interconnect network (LIN) bus, a FlexRay bus, an automotive ethernet bus, an inter-integrated circuit bus, and/or a serial peripheral interface bus, among other examples). The processor 310 may include a central processing unit, a graphics processing unit, a microprocessor, a controller, a microcontroller, a digital signal processor, a field-programmable gate array, an application-specific integrated circuit, and/or another type of processing component. The processor 310 may be implemented in hardware, firmware, or a combination of hardware and software. In some aspects, the processor 310 may include one or more processors capable of being programmed to perform one or more operations or processes described elsewhere herein.

The memory 315 may include volatile and/or nonvolatile memory. For example, the memory 315 may include random access memory (RAM), read only memory (ROM), a hard disk drive, and/or another type of memory (e.g., a flash memory, a magnetic memory, and/or an optical memory). The memory 315 may include internal memory (e.g., RAM, ROM, or a hard disk drive) and/or removable memory (e.g., removable via a universal serial bus connection). The memory 315 may be a non-transitory computer-readable medium. The memory 315 may store information, one or more instructions, and/or software (e.g., one or more software applications) related to the operation of the device 300. In some aspects, the memory 315 may include one or more memories that are coupled (e.g., communicatively coupled) to one or more processors (e.g., processor 310), such as via the bus 305. Communicative coupling between a processor 310 and a memory 315 may enable the processor 310 to read and/or process information stored in the memory 315 and/or to store information in the memory 315.

The input component 320 may enable the device 300 to receive input, such as user input and/or sensed input. For example, the input component 320 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 325 may enable the device 300 to provide output, such as via a display, a speaker, and/or a light-emitting diode. The communication component 330 may enable the device 300 to communicate with other devices via a wired connection and/or a wireless connection. For example, the communication component 330 may include a receiver, a transmitter, a transceiver, a modem, a network interface card, and/or an antenna.

The lidar sensor 115 may be configured to capture data points representing one or more objects in an environment around the first vehicle. In some aspects, the lidar sensor 115 may output, via the bus 305, a point cloud that can be used to generate an initial bounding geometry associated with the one or more sensed objects. In some aspects, the point cloud output by the lidar sensor 115 may include one or more data points. In some aspects, the one or more data points may represent two or more scans of an environment that includes a sensed object.

An object detector 335 may be configured to receive the point cloud output by the lidar sensor 115 and generate the initial bounding geometry associated with the one or more sensed objects. In some aspects, the initial bounding geometry generated by the object detector 335 may have a bounding volume. In some aspects, the bounding volume of the initial bounding geometry may be associated with a size of the sensed object as detected by the lidar sensor 115. In some aspects, the object detector 335 may be included in the processor 310. In some aspects, the object detector 335 may output the initial bounding geometry to the bus 305, and the processor 310 may receive or otherwise access the initial bounding geometry via the bus 305. In some aspects, the initial bounding geometry may be stored in the memory 315. In some aspects, the processor 310 may access or otherwise receive the initial bounding geometry from the memory 315.

The device 300 may perform one or more operations or processes described herein. For example, a non-transitory computer-readable medium (e.g., memory 315) may store a set of instructions (e.g., one or more instructions or code) for execution by the processor 310. The processor 310 may execute the set of instructions to perform one or more operations or processes described herein. In some aspects, execution of the set of instructions, by one or more processors 310, causes the one or more processors 310 and/or the device 300 to perform one or more operations or processes described herein. In some aspects, hardwired circuitry may be used instead of or in combination with the instructions to perform one or more operations or processes described herein. Additionally, or alternatively, the processor 310 may be configured to perform one or more operations or processes described herein. Thus, aspects described herein are not limited to any specific combination of hardware circuitry and software.

In some aspects, device 300 may include means for receiving a bounding geometry associated with one or more data points of a point cloud representing two or more scans of an environment that includes a sensed object. The bounding geometry may have a bounding volume associated with the sensed object. In some aspects, the device 300 includes means for extending the bounding volume of the bounding geometry to enclose at least a subset of the data points in the point cloud; means for estimating a data point displacement in accordance with two or more subsets of the data points of the point cloud; and/or means for estimating a velocity of the sensed object in accordance with the data point displacement. In some aspects, the means for device 300 to perform processes and/or operations described herein may include one or more components of device 300 described in connection with FIG. 3, such as bus 305, processor 310, memory 315, input component 320, output component 325, communication component 330, the object detector 335, and/or the lidar sensor 115.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

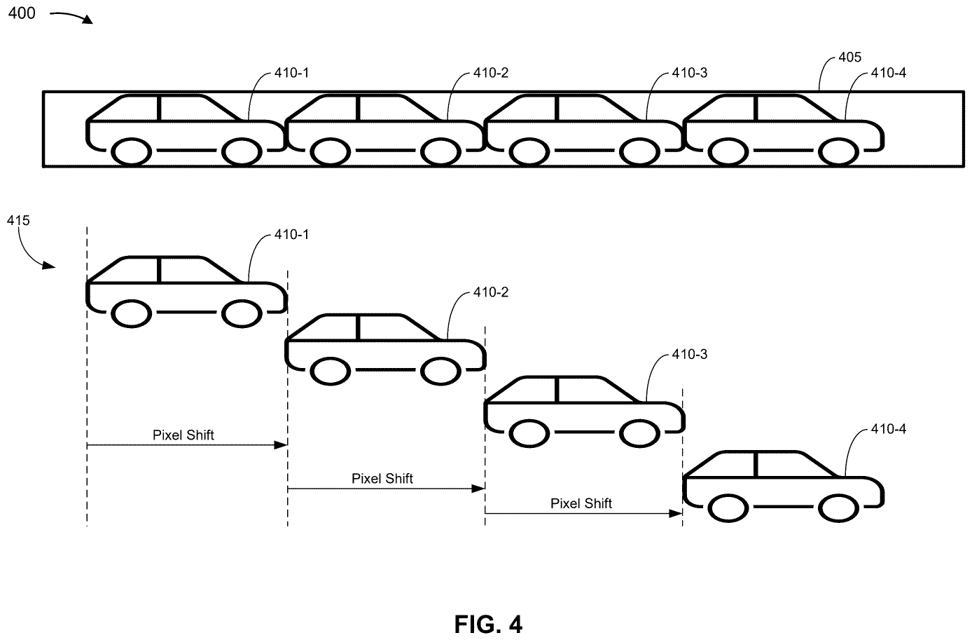

FIG. 4 is a diagram illustrating an example 400 associated with processing a bounding geometry, in accordance with the present disclosure. In some aspects, the processing of the bounding geometry may be performed, individually or collectively, by one or more components of the device 300, discussed above.

As shown in FIG. 4, example 400 includes an extended bounding volume 405 in accordance with multiple scans 410 of an environment that includes a sensed object (e.g., the second vehicle 110 of FIGS. 1 and 2). In some aspects, the lidar sensor may output a point cloud representing data points collected during a first scan 410-1, a second scan 410-2, a third scan 410-3, and a fourth scan 410-4, among other examples. In some aspects, the bounding volume of the initial bounding geometry may be extended to enclose at least a subset of the data points in the point cloud. For example, the bounding volume 405 may be extended to include at least the data points associated with the first scan 410-1, the second scan 410-2, the third scan 410-3, and/or the fourth scan 410-4, among other examples. In some aspects, extending the bounding volume 405 of the bounding geometry may include extending the bounding volume 405 in a direction of travel of the sensed object.

In some aspects, the processing performed by the device (e.g., one or more components of the device 300 of FIG. 3) may estimate a data point displacement. In some aspects, the data point displacement may be estimated in accordance with two or more subsets of the data points of the point cloud. For example, the data point displacement may be estimated in accordance with data points associated with the first scan 410-1, the second scan 410-2, the third scan 410-3, and/or the fourth scan 410-4, among other examples.

In some aspects, as shown by reference number 415, estimating the data point displacement may include generating two or more orthographic projections. In some aspects, each of the orthographic projections may be associated with one of the scans of the sensed object. For example, each orthographic projection may be associated with the first scan 410-1, the second scan 410-2, the third scan 410-3, or the fourth scan 410-4. In some aspects, estimating the data point displacement may include calculating a pixel shift. The pixel shift may be associated with the orthographic projections. For example, the pixel shift may be associated with calculating a change in corresponding pixels between two or more scans of the sensed object. For example, in some aspects, the pixel shift may be associated with a change in corresponding pixels between the first scan 410-1, the second scan 410-2, the third scan 410-3, and/or the fourth scan 410-4. In some aspects, the pixel shift may be calculated as a mean pixel shift or a median pixel shift, among other examples. In some aspects, the data point displacement may be estimated, individually or collectively, by one or more components of the device 300 of FIG. 3.

In some aspects, the velocity of the sensed object may be estimated in accordance with the data point displacement. In some aspects, the velocity of the sensed object may be estimated in accordance with the times at which each scan 410 occurred and the data point displacement. In some aspects, other characteristics of the sensed object may be estimated in accordance with the data point displacement. For example, in some aspects, one or more of a yaw angle, a yaw rate, an acceleration, and/or a combination thereof, among other examples, of the sensed object may be estimated in accordance with the data point displacement. In some aspects, the velocity, yaw rate, yaw angle, and/or acceleration of the sensed object may be estimated, individually or collectively, by one or more components of the device 300 of FIG. 3.

As indicated above, FIG. 4 is provided as an example. Other examples may differ from what is described with respect to FIG. 4.

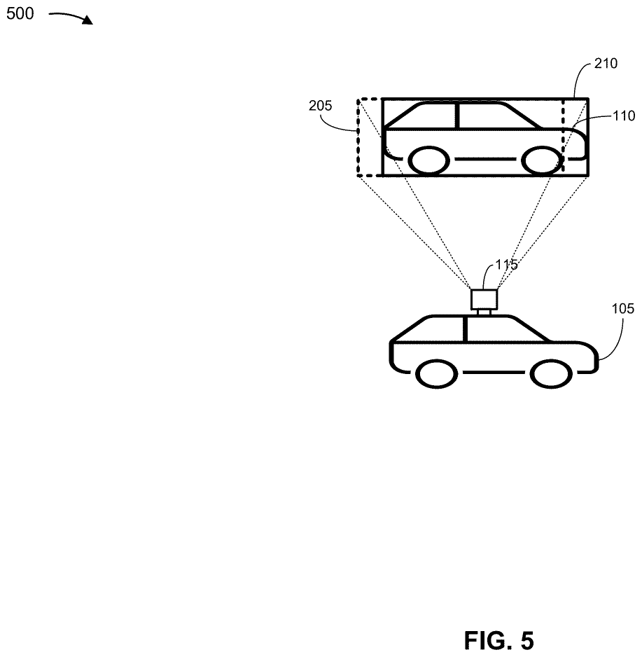

FIG. 5 is a diagram illustrating an example 500 associated with generating a corrected bounding geometry, in accordance with the present disclosure. For example, in some aspects, one or more components of the device 300 of FIG. 3, individually or collectively, may be configured to determine one or more compensation vectors. In some aspects, the compensation vectors may be based on the estimated velocity of the sensed object, the estimated data point displacement, and/or a combination thereof, among other examples. In some aspects, the compensation vectors may account for the distortion of the initial bounding geometry discussed above with respect to FIG. 1. In some aspects, the compensation vectors may be applied to the initial bounding geometry 205 (see FIG. 2). In some aspects, one of the compensation vectors may be applied to each selected data point of the initial bounding geometry. In some aspects, the selected data points may be a subset of the data points in the point cloud. Accordingly, in some aspects, only one compensation vector may be applied to each selected data point, but not all data points may be adjusted via a compensation vector. Alternatively, in some aspects, one of the compensation vectors may be applied to all of the data points of the initial bounding geometry (e.g., every data point in the point cloud may be a selected data point). Accordingly, in some aspects, every data point in the point cloud may have a compensation vector applied. In some aspects, two or more of the compensation factors applied to two or more selected data points, respectively, may be different from one another. In some aspects, two or more of the compensation factors applied to two or more selected data points, respectively, may be the same as one another. In some aspects, applying the compensation vectors may result in a corrected bounding geometry 210. In some aspects, the corrected bounding geometry 210 may represent the sensed object more accurately than the initial bounding geometry 205. In some aspects, the corrected bounding geometry 210 may represent the sensed object as it appeared relative to the lidar sensor at time T₁. For example, by applying the compensation vectors to the selected data points of the sensed object, the distortion caused by the delay in collecting the data points may be removed. Accordingly, the corrected bounding geometry 210 may more accurately represent the sensed object than the initial bounding geometry 205.

As indicated above, FIG. 5 is provided as an example. Other examples may differ from what is described with respect to FIG. 5.

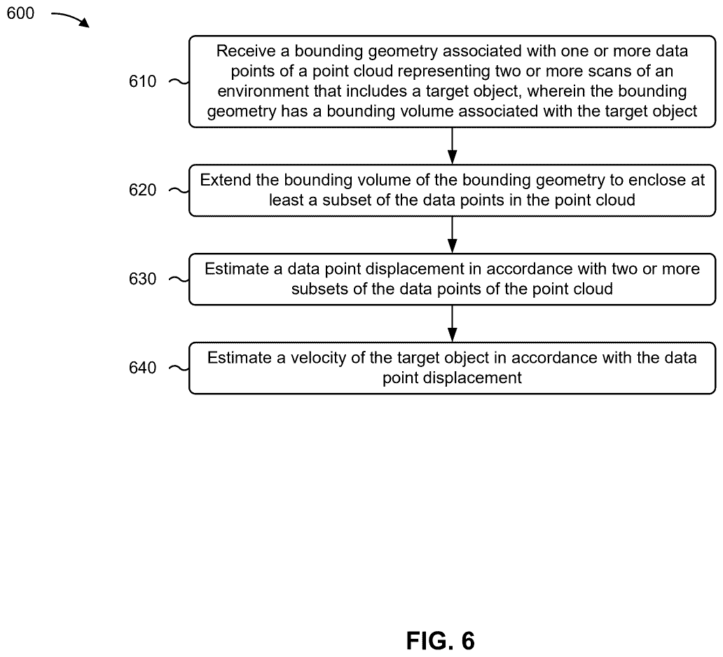

FIG. 6 is a flowchart of an example process 600 associated with velocity estimation distortion correction, in accordance with the present disclosure. In some aspects, one or more process blocks of FIG. 6 are performed by an apparatus (e.g., one or more components, individually or collectively, of the device 300 of FIG. 3). In some aspects, one or more process blocks of FIG. 6 are performed by another device or a group of devices separate from or including the apparatus, such as a lidar sensor (e.g., lidar sensor 115). Additionally, or alternatively, one or more process blocks of FIG. 6 may be performed by one or more components of device 300, such as processor 310, memory 315, input component 320, output component 325, and/or communication component 330.

As shown in FIG. 6, process 600 may include receiving a bounding geometry associated with one or more data points of a point cloud representing two or more scans of an environment that includes a sensed object. The bounding geometry may have a bounding volume associated with the sensed object (block 610). For example, the apparatus may receive a bounding geometry associated with one or more data points of a point cloud representing two or more scans of an environment that includes a sensed object, wherein the bounding geometry has a bounding volume associated with the sensed object, as described above.

As further shown in FIG. 6, process 600 may include extending the bounding volume of the bounding geometry to enclose at least a subset of the data points in the point cloud (block 620). For example, the apparatus may extend the bounding volume of the bounding geometry to enclose at least a subset of the data points in the point cloud, as described above.

As further shown in FIG. 6, process 600 may include estimating a data point displacement in accordance with two or more subsets of the data points of the point cloud (block 630). For example, the apparatus may estimate a data point displacement in accordance with two or more subsets of the data points of the point cloud, as described above.

As further shown in FIG. 6, process 600 may include estimating a velocity of the sensed object in accordance with the data point displacement (block 640). For example, the apparatus may estimate a velocity of the sensed object in accordance with the data point displacement, as described above.

Process 600 may include additional aspects, such as any single aspect or any combination of aspects described below and/or in connection with one or more other processes described elsewhere herein.

In a first aspect, estimating the data point displacement includes generating two or more orthographic projections, wherein each of the two or more orthographic projections is associated with one of the two or more scans of the sensed object, and calculating a pixel shift associated with the two or more orthographic projections.

In a second aspect, alone or in combination with the first aspect, calculating the pixel shift includes calculating a mean pixel shift or a median pixel shift.

In a third aspect, alone or in combination with one or more of the first and second aspects, process 600 includes determining one or more compensation vectors in accordance with the estimated velocity of the sensed object.

In a fourth aspect, alone or in combination with one or more of the first through third aspects, the bounding geometry is an initial bounding geometry for the sensed object in accordance with the point cloud.

In a fifth aspect, alone or in combination with one or more of the first through fourth aspects, process 600 includes applying one or more compensation vectors to the bounding geometry to generate a corrected bounding geometry for the sensed object.

In a sixth aspect, alone or in combination with one or more of the first through fifth aspects, applying the one or more compensation vectors includes applying one of the one or more compensation vectors to each selected point of the bounding geometry.

In a seventh aspect, alone or in combination with one or more of the first through sixth aspects, extending the bounding volume of the bounding geometry includes extending the bounding volume in a direction of travel of the sensed object.

In an eighth aspect, alone or in combination with one or more of the first through seventh aspects, process 600 includes estimating one or more of a yaw angle or a yaw rate of the sensed object in accordance with the data point displacement.

In a ninth aspect, alone or in combination with one or more of the first through eighth aspects, process 600 includes estimating an acceleration of the sensed object in accordance with the data point displacement.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: A method, comprising: receiving a bounding geometry associated with one or more data points of a point cloud representing two or more scans of an environment that includes a sensed object, wherein the bounding geometry has a bounding volume associated with the sensed object; extending the bounding volume of the bounding geometry to enclose at least a subset of the data points in the point cloud; estimating a data point displacement in accordance with two or more subsets of the data points of the point cloud; and estimating a velocity of the sensed object in accordance with the data point displacement.

Aspect 2: The method of Aspect 1, wherein estimating the data point displacement includes: generating two or more orthographic projections, wherein each of the two or more orthographic projections is associated with one of the two or more scans of the sensed object; and calculating a pixel shift associated with the two or more orthographic projections.

Aspect 3: The method of Aspect 2, wherein calculating the pixel shift includes calculating a mean pixel shift or a median pixel shift.

Aspect 4: The method of any of Aspects 1-3, further comprising determining one or more compensation vectors in accordance with the estimated velocity of the sensed object.

Aspect 5: The method of any of Aspects 1-4, wherein the bounding geometry is an initial bounding geometry for the sensed object in accordance with the point cloud.

Aspect 6: The method of any of Aspects 1-5, further comprising: applying one or more compensation vectors to the bounding geometry to generate a corrected bounding geometry for the sensed object.

Aspect 7: The method of Aspect 6, wherein applying the one or more compensation vectors includes applying one of the one or more compensation vectors to each selected point of the bounding geometry.

Aspect 8: The method of any of Aspects 1-7, wherein extending the bounding volume of the bounding geometry includes extending the bounding volume in a direction of travel of the sensed object.

Aspect 9: The method of any of Aspects 1-8, further comprising estimating one or more of a yaw angle or a yaw rate of the sensed object in accordance with the data point displacement.

Aspect 10: The method of any of Aspects 1-9, further comprising estimating an acceleration of the sensed object in accordance with the data point displacement.

Aspect 11: A system configured to perform one or more operations recited in one or more of Aspects 1-10.

Aspect 12: An apparatus comprising means for performing one or more operations recited in one or more of Aspects 1-10.

Aspect 13: A non-transitory computer-readable medium storing a set of instructions, the set of instructions comprising one or more instructions that, when executed by a device, cause the device to perform one or more operations recited in one or more of Aspects 1-10.

Aspect 14: A computer program product comprising instructions or code for executing one or more operations recited in one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus, comprising:
one or more memories; and
one or more processors, coupled to the one or more memories, configured to cause the apparatus to:
receive a bounding geometry associated with one or more data points of a point cloud representing two or more scans of an environment that includes a sensed object, wherein the bounding geometry has a bounding volume associated with the sensed object;
extend the bounding volume of the bounding geometry to enclose at least a subset of the data points in the point cloud;
estimate a data point displacement in accordance with two or more subsets of the data points of the point cloud; and
estimate a velocity of the sensed object in accordance with the data point displacement.

2. The apparatus of claim 1, wherein the one or more processors, to cause the apparatus to estimate the data point displacement, are configured to cause the apparatus to:
generate two or more orthographic projections, wherein each of the two or more orthographic projections is associated with one of the two or more scans of the sensed object; and
calculate a pixel shift associated with the two or more orthographic projections.

3. The apparatus of claim 2, wherein the one or more processors, to cause the apparatus to calculate the pixel shift, are configured to cause the apparatus to calculate a mean pixel shift or a median pixel shift.

4. The apparatus of claim 1, wherein the one or more processors are further configured to cause the apparatus to determine one or more compensation vectors in accordance with the estimated velocity of the sensed object.

5. The apparatus of claim 1, wherein the bounding geometry is an initial bounding geometry for the sensed object in accordance with the point cloud.

6. The apparatus of claim 1, wherein the one or more processors are further configured to cause the apparatus to apply one or more compensation vectors to the bounding geometry to generate a corrected bounding geometry for the sensed object.

7. The apparatus of claim 6, wherein the one or more processors, to cause the apparatus to apply the one or more compensation vectors, are configured to cause the apparatus to apply one of the one or more compensation vectors to each selected point of the bounding geometry.

8. The apparatus of claim 1, wherein the one or more processors, to cause the apparatus to extend the bounding volume of the bounding geometry, are configured to cause the apparatus to extend the bounding volume in a direction of travel of the sensed object.

9. The apparatus of claim 1, wherein the one or more processors are further configured to cause the apparatus to estimate one or more of a yaw angle or a yaw rate of the sensed object in accordance with the data point displacement.

10. The apparatus of claim 1, wherein the one or more processors are further configured to cause the apparatus to estimate an acceleration of the sensed object in accordance with the data point displacement.

11. A method, comprising:
receiving a bounding geometry associated with one or more data points of a point cloud representing two or more scans of an environment that includes a sensed object, wherein the bounding geometry has a bounding volume associated with the sensed object;
extending the bounding volume of the bounding geometry to enclose at least a subset of the data points in the point cloud;
estimating a data point displacement in accordance with two or more subsets of the data points of the point cloud; and
estimating a velocity of the sensed object in accordance with the data point displacement.

12. The method of claim 11, wherein estimating the data point displacement includes:
generating two or more orthographic projections, wherein each of the two or more orthographic projections is associated with one of the two or more scans of the sensed object; and
calculating a pixel shift associated with the two or more orthographic projections.

13. The method of claim 12, wherein calculating the pixel shift includes calculating a mean pixel shift or a median pixel shift.

14. The method of claim 11, further comprising determining one or more compensation vectors in accordance with the estimated velocity of the sensed object.

15. The method of claim 11, wherein the bounding geometry is an initial bounding geometry for the sensed object in accordance with the point cloud.

16. The method of claim 11, further comprising applying one or more compensation vectors to the bounding geometry to generate a corrected bounding geometry for the sensed object, wherein applying the one or more compensation vectors includes applying one of the one or more compensation vectors to each selected point of the bounding geometry.

17. The method of claim 11, wherein extending the bounding volume of the bounding geometry includes extending the bounding volume in a direction of travel of the sensed object.

18. The method of claim 11, further comprising estimating one or more of a yaw angle or a yaw rate of the sensed object in accordance with the data point displacement.

19. The method of claim 11, further comprising estimating an acceleration of the sensed object in accordance with the data point displacement.

20. An apparatus for wireless communication, comprising:
means for receiving a bounding geometry associated with one or more data points of a point cloud representing two or more scans of an environment that includes a sensed object, wherein the bounding geometry has a bounding volume associated with the sensed object;
means for extending the bounding volume of the bounding geometry to enclose at least a subset of the data points in the point cloud;
means for estimating a data point displacement in accordance with two or more subsets of the data points of the point cloud; and
means for estimating a velocity of the sensed object in accordance with the data point displacement.
